(19) United States
(12) Patent Application Publication
(10) Pub. No.: US 2006/0085756 A1
(43) Pub. Date: Apr. 20, 2006

(54) Method and an apparatus for a collaborative clip board

(75) Inventors: Alok Z. Srivastava, Moraga, CA (US); Jeremy Chone, San Francisco, CA (US)

Correspondence Address: WAGNER, MURABITO & HAO LLP, Third Floor, Two North Market Street, San Jose, CA, 95113, US

(73) Assignee: ORACLE INTERNATIONAL CORPORATION, REDWOOD SHORES, CA (US)

(21) Appl. No.: 10/966,256

(22) Filed: Oct. 15, 2004

(51) Int. Cl. G06F 17/00

(52) U.S. Cl. 715/770

(57) ABSTRACT

Embodiments of the present invention are directed to a method and an apparatus for a collaborative clip board. In one embodiment, a plurality of objects are collected into temporary storage associated with a collaborative clip board based on user specified information. A relationship specified by the user is established between a group of the plurality of objects. A user specified action is received and performed on the group of objects.

### BACKGROUND OF THE INVENTION

1. Field of the Invention

Embodiments of the present invention relate to the field of collaborative interactions using computerized tools. More specifically, embodiments of the present invention relate provide collaborative interactions using computerized tools.

2. Related Art

Collaborative interactions involve interactions between people using computerized tools in order to achieve a goal. For example, a person may want to schedule a meeting for reviewing documents. In this case, a person may use email (e.g., a computerized tool) to attach the documents, copy the people who should attend the meeting and type in a message indicating the date and place of the review.

Today, collaborative interactions involve selecting a tool, such as email, for the interaction, as well as determining and collecting the information that will be used with the tool. Continuing the example, the person first selected email as their tool of choice for scheduling the meeting to review the documents. Then the person would have to determine what information would be associated with the email by determining what people should review the document, what date would be best for scheduling the meeting on, what documents are to be reviewed, etc. Finally, the person would associate the information with the tool by attaching the documents that are to be reviewed, copying the people who should attend the meeting, and typing the message into the email specifying the date and place of the review.

However, the person may want to do something else with the information they collected to schedule the review meeting. For example, the person may want to schedule another meeting with the same people to review other documents or the person may want to use a calendaring tool to track activities, such as reviewing the documents. In the first case, the person would have to create a new email, copy the same people on the email, type in a message that may be very similar to the message for the first email, and attach the new documents to the email. In the second case, the person scheduling the meeting would have to type the date of the review meeting into the calendaring tool, type in text describing the review meeting, and type in the names of the people who will attend the review meeting. The date that that the person typed into the message for the first email would be the same as the date that the person would need to enter into the calendaring tool. The text describing the review meeting may be the same or very similar to the message for the first email. In either case, the person would have to re-collect at least some of the information that they had collected for the first email.

Therefore, it would be valuable to provide a method and an apparatus that could allow a more natural process of collecting information for use with a computerized tool and possibly even reusing the information with the same or a different computerized tool.

### SUMMARY OF THE INVENTION

Embodiments of the present invention are directed to a method and an apparatus for a collaborative clip board. In one embodiment, a plurality of objects are collected into temporary storage associated with a collaborative clip board based on user specified information. A relationship specified by the user is established between a group of the plurality of objects. A user specified action is received and performed on the group of objects.

In one embodiment, the collaborative clip board is a graphical user interface (GUI). Examples of objects that can be collected include, among other things, information about a person, a document, a message, a date, a description, and a place. The user can specify the relationship, for example, by dragging and dropping visual representations of objects on top of each other. Examples of actions that can be performed on the objects include messaging, inviting, scheduling, and calendaring. A list of potential actions can be provided for the user to select from. In so doing, a more natural process of collecting information (e.g., objects) is provided in order to perform actions on the information, for example, using a computerized tool. According to another embodiment, objects can be stored in permanent storage and retrieved for the purposes of performing a different action on one or more of the objects. In so doing, the objects can be reused with the same or a different computerized tool.

### BRIEF DESCRIPTION OF THE DRAWINGS

FIG. 1 illustrates a block diagram of a computer system which includes a collaborative clip board, according to embodiments of the present invention.

FIG. 2 illustrates another block diagram of a computer system that includes collaborative clip board, according to other embodiments of the present invention.

FIGS. 3A, 3B, 3C illustrates a flow diagram of a process for using a collaborative clipboard, according to embodiments of the present invention.

FIG. 4 which illustrates an exemplary computer system upon which embodiments of the present invention can be practiced.

### DETAILED DESCRIPTION OF THE INVENTION

Reference will now be made in detail to the preferred embodiments of the present invention, a method and system are described for implementing a collaborative clip board, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

Typically, when people want to accomplish a goal, such as organizing a party or reviewing a document, they first think about the information (e.g., the people that they need to invite, the date the event will occur, what they need to bring, etc.) that they need in order to accomplish the goal, then they think about what tools (e.g., such as email, calendars, etc.) they can use to accomplish the goal. Frequently, the natural way that people accomplish a goal involves brain storming about the information while making notes about the information, for example, on a piece of paper.

Further, they will think about the relationships between various parts of the information. For example, there may be 10 people in a team that is working on a project to develop a piece of software. Various documents may be produced as a part of developing the software. If the goal is to review a document, only a group of the people on the team may be needed to review the document. In a second example, a person may have 30 friends but they may realize that only a group of their friends are interested in attending a particular type of party that they are planning. As a part of planning this party, the person may need to write down most of their friends' names and think about which ones would be interested in attending this type of party. Therefore, there are “relationships” between the various pieces of information the person is thinking about, according to another embodiment. In the first example, there is a relationship between the document that needs to be reviewed, the people that will review the document, the date the document will be reviewed, etc. In the second example, there is a relationship between not only the people attending the party, the date of the party, the place the party will occur at, but also the things that should be bought for the party, among other things. According to one embodiment, the information that is collected shall be referred to as “objects.” Examples of these objects include but are not limited to people, documents, dates, descriptions, messages, etc.

According to one embodiment, an electronic “collaborative clipboard” enables the collection of objects and the establishment of relationships between the objects in a way that is natural to people, as already described herein. The collaborative clipboard can be a graphical user interface (GUI) and the objects can be “collected” by associating visual representations of the objects with the GUI, as will become more evident. Although, the term “object” is used to refer to various types of information, embodiments of this invention do not require object oriented programming. A number of different programming language can be used for implementing the embodiments described herein.

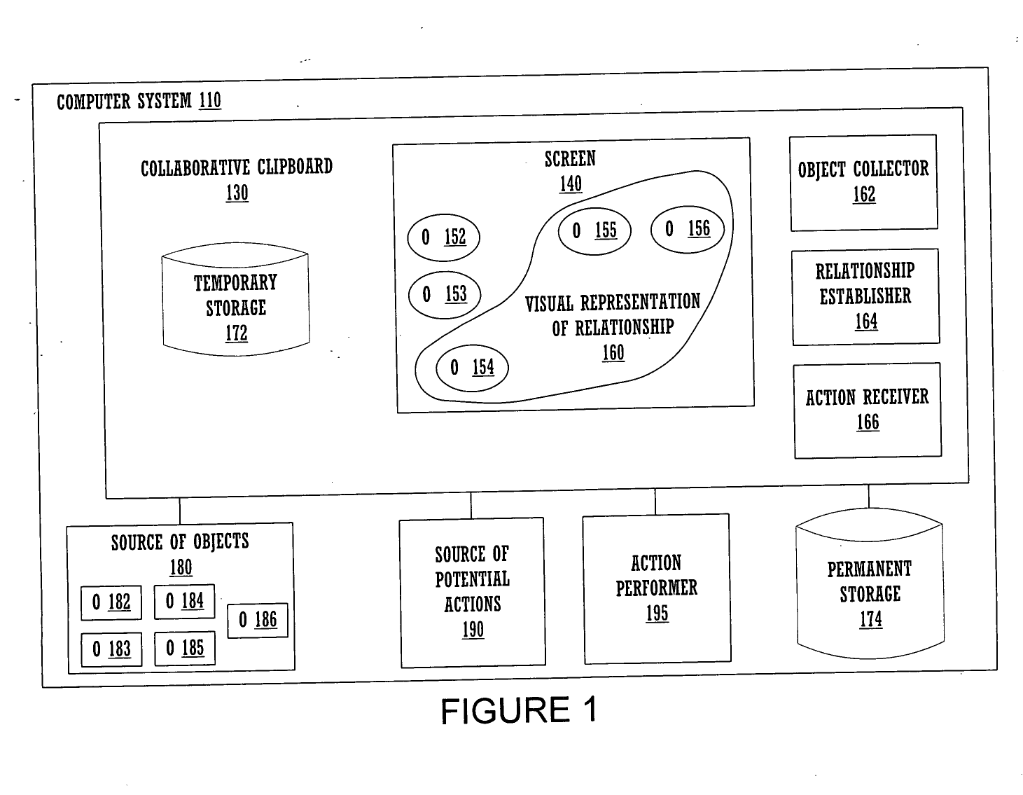

FIG. 1 illustrates a block diagram of a computer system 110 which includes a collaborative clip board 130, according to embodiments of the present invention. The blocks can be arranged differently than as illustrated, and can implement more or fewer features than what are illustrated. Further, the features represented by the blocks depicted in FIG. 1 can be combined in various ways.

As depicted in FIG. 1 embodiment, the collaborative clip board 130 is be a generalized user interface. In this case, the collaborative clip board 130 can display visual representations 152-156 of a plurality of objects 182-186, which a user is interested in collecting on a computer screen 140. The plurality of objects 182-186 can be obtained from a source objects 180. Further, the collaborative clip board 130 can display a visual representation of a relationship 160 between visual representations 154-156 of a group 184-186 of the plurality of objects 184-186.

The collaborative clip board 130 includes an object collector 162, a relationship establisher 164, an action receiver 166, temporary storage 172 for storing the plurality of objects 182-186 and for storing a relationship between the group 184-186. The collaborative clip board 130 can interact with the source of objects 180, a source of potential actions 190, an action performer 195, and permanent storage 174.

An object collector 162 can receive information that indicates the plurality of objects 182-186 the user specified, and cause the visual representations 152-156 of the plurality of objects 182-186 to be displayed on the computer screen 140.

The collaborative clip board 130 can establish a relationship between the group 184-186, according to yet another embodiment. For example, a relationship establisher 164 can receive information for establishing the relationship between the group 184-186 and can cause the visual representation of the relationship 160 to be displayed on the computer screen 140. According to one embodiment, a group of objects can include all of the objects that are associated with the plurality of objects 182-186.

The relationship establisher 164 can receive information (e.g., specifying objects 184-186) designated by the user to establish the relationship, according to one embodiment. A relationship between the group of objects 184-186 can be established by dragging and dropping visual representations of objects 154-156 on top of each other. For example, the visual representation of object 154 can be dragged and dropped on top of the visual representation of object 155, and the visual representation of object 155 can be dragged and dropped on top of the visual representation of object 156, and so on, to establish a relationship between the group of objects 184-186. A relationship between a group of objects 184-186 can be established by drawing around visual representations 154-186 of the group 184-186. For example, a Java Script™ can be used to implement a drawing mechanism for drawing around visual representations. A user could use their mouse to place their cursor at a starting position, click their mouse, move their mouse around the objects to draw around the visual representations 154-156 associated with the group 184-186. When the user has drawn around the desired visual representations 154-156, they can click their mouse again to end the drawing procedure.

The collaborative clip board 130 can perform an action on the group 184-186 of objects 182-186 based on the relationship, according to still another embodiment. For example, the collaborative clip board 130 can display a list of potential actions for the user to choose from. The user can select an action from the list that the user wants the collaborative clip board 130 to perform on the group 184-186 of objects 182-186 associated with the relationship. An action performer 195 can perform the action the user selected on the group 184-186 of objects 182-186.

Although an object collector 162, a relationship establisher 164, and an action receiver 166 are depicted with separate blocks in FIG. 1, code implementing the features associated with the object collector 162, the relationship establisher 164, and/or the action receiver 166 can be combined in various ways, according to one embodiment. For example, the object collector 162, the relationship establisher 164, and/or the action receiver 166 can be combined into a collaboration engine.

According to one embodiment, the collaborative clip board 130 can store one or more of the plurality of objects 182-186, and the relationship in permanent storage 174, allowing the modification of the stored objects and/or the relationship, for example, at a future point in time. According to another embodiment, the one ore more of objects 182-186 and the relationship can be stored as a “workspace” in permanent storage 174.

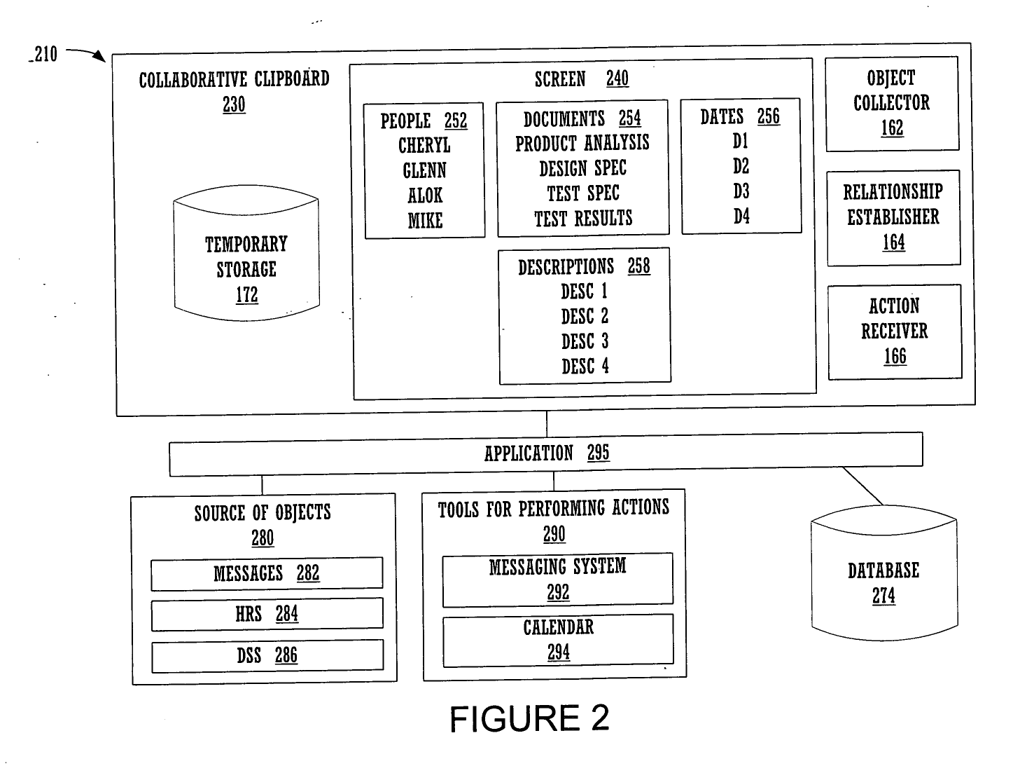

FIG. 2 illustrates another block diagram of a computer system 210 that includes a collaborative clip board 230, according to other embodiments of the present invention. The blocks can be arranged differently than as illustrated, and can implement more or fewer features than what are illustrated. Further, the features represented by the blocks depicted in FIG. 2 can be combined in various ways.

FIG. 2 depicts a three tiered computer system 210. The three tiers include a client tier, middle ware tier, and data tier. As depicted in FIG. 2, the client tier can include the collaborative clip board 230, the middle ware tier can include the application 295, and the data tier can include the source of objects 280, the source of potential actions (e.g., tools for performing actions 290), and the permanent storage (e.g., the database 274), according to one embodiment. According to another embodiment, the application 295 is Oracle's Collaborative Suite™ (OCS), however, the collaborative clip board 230 can interface with any product that provides the functionality of application 295.

According to yet another embodiment, the database 274 can be an object oriented data base. In this case, the application 295 can include methods (e.g., object classes) that operate on the values (e.g., data stored in the database 274) of the attributes associated with the object classes. For example, there can be methods associated with the application 295 for operating on information (e.g., data) about people 252, documents 254, etc. that is stored in the database 274.

The objects that can be collected by the collaborative clip board 230 include, but are not limited to, information about a person, a document, a message, a date, a description, and a place, among other things, according to one embodiment. For example, as depicted in FIG. 2 source of objects 280 depicts messages 282, for example, from emails, a human resource system 284 that information about people 252 can be obtained from, and a document source system 286 that documents 254 can be obtained from. The computer screen 240 depicts visual representations of people 252 (such as their names) that can be obtained, for example, from a human resource system 284. The computer screen 240 also depicts visual representations of documents 254 that can be obtained from a document source system 286. The user can type dates 256 directly into a computer system 210 causing the computer screen 240 to display the dates 256. The visual representations of descriptions 258, displayed on the computer screen 240, can be typed directly into the computer system 210 or obtained from a source of objects 280.

The collaborative clip board 230 can establish a relationship between a group of objects, according to one embodiment. For example, the user can coordinate a review meeting of a product analysis document. The product analysis document may need to be reviewed by Cheryl, Glen, and Mike. The user may want to coordinate the review meeting to occur on a particular date, such as date D1. To accomplish this, the user can cause the collaborative clip board 230, according to one embodiment, to establish a relationship between the document that is to be reviewed (e.g., product analysis document), the people 252 who will be invited to review the document (e.g., Cheryl, Glen, and Mike), the date (e.g., D1) the review is scheduled for, and a description desc 1, such as “scheduling meeting to review product analysis document,” of what is to occur.

One aspect of coordinating a review meeting can, for example, involve sending an email to Cheryl, Glen, and Mike, attaching the product analysis document to the email, etc. In this case, the collaborative clip board 230 can provide a list of actions that can be performed on the specified group of objects, according to one embodiment. For example, the tools for performing actions 290 can provide a list of potential actions to the collaborative clip board 230 that can be performed on the group of objects. The collaborative clip board 230 can display the list for the user to select an action from, according to another embodiment. The list of potential actions can include, among other things, messaging, calendaring, inviting, scheduling, according to yet another embodiment. Visual representations of the list of potential actions can be displayed to the user with a pop up window, according to still another embodiment.

The user can select, for example, the action “messaging” in which case, according to one embodiment, a message (e.g., email) can be transmitted using the relationship and the group of objects. In this case, the collaborative clip board 230 can automatically cause the message to include a “cc:” to Cheryl, Glenn, and Mike, the product analysis document to be attached to the message, the description of the message to include text for the description desc1 and the body of the message to include the date D1. The user can type in additional text for the message content. The message can be transmitted to the people designated on the “cc:.”. The user can save one or more of the plurality of objects and the relationship into permanent storage, such as a database 274.

Another aspect of coordinating the review meeting can involve entering information into a calendar 294. In this case, the user may want to reuse the stored objects and the relationship, according to one embodiment. The user can retrieve the stored objects and the relationship from permanent storage (such as the database 274) and associate the retrieved information with another tool, such as the calendar 294. In this case, the user can select “calendaring,” for example, from the list of potential actions provided by the tools for performing actions 290 causing the retrieved objects (e.g., Cheryl, Glen, Mike, product analysis document, date D1, description desc1) to be associated with the calendar 294.

The tools for performing actions 290 provides a source of potential actions 190, according to one embodiment, as well as an action performer 195, according to another embodiment. For example, the tools for performing actions 290 can provide a list of potential actions (e.g., messaging, calendaring, inviting, scheduling), as well as perform the actions (e.g., send the message, enter information into a calendar 294, etc.). According to another embodiment, the tools for performing actions 290 can include legacy tools. For example, the messaging system can be Microsoft's Outlook™.

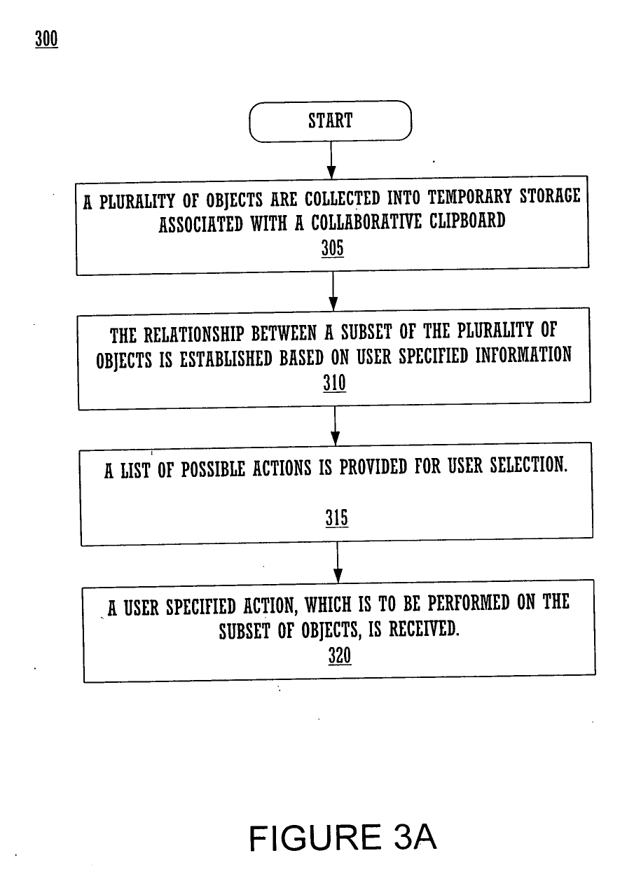

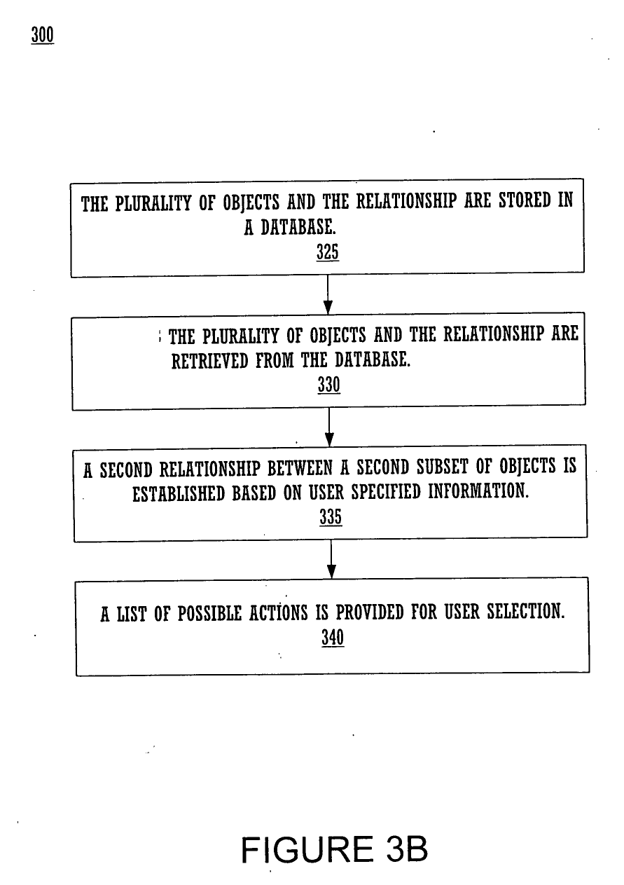

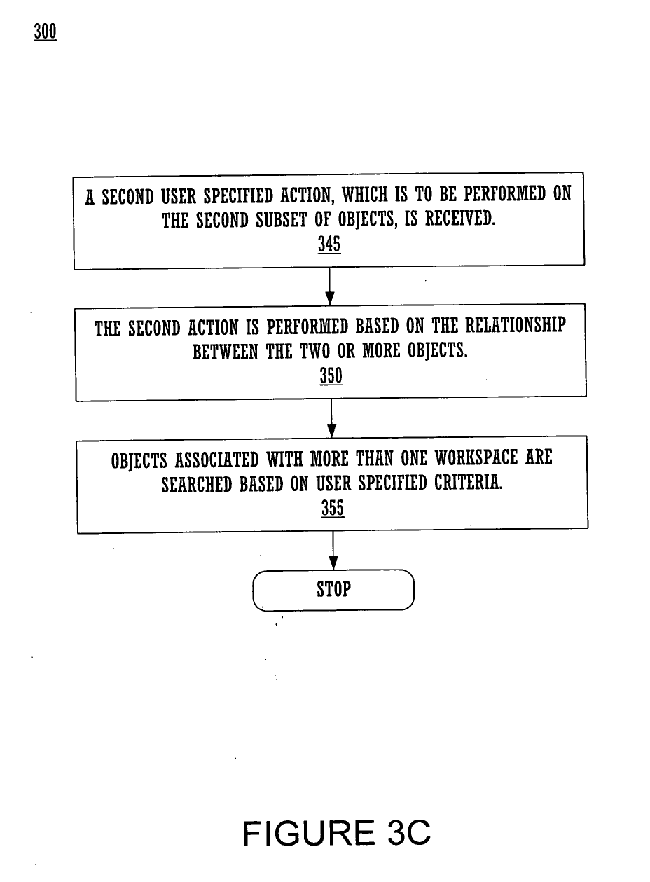

FIGS. 3A, 3B, 3C illustrates a flow diagram of a process 300 for using a collaborative clipboard, according to embodiments of the present invention. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed. All of, or a portion of, the embodiments described by flowchart 300 can be implemented using computer-readable and computer-executable instructions which reside, for example, in computer-usable media of a computer system or like device. In the present embodiment, steps depicted in flowchart 300 may be implemented by structures depicted in FIG. 2. In the present embodiment, the collaborative clipboard can be executed on the computer system 390.

At step 305 of FIG. 3A, a plurality of objects are collected into temporary storage associated with a collaborative clip board 230, according to one embodiment. For example, the user can cause the collaborative clip board 230 to display visual representations of the plurality of objects, such as people 252, documents 254, dates 256, descriptions 258, etc., on a computer screen 240. In this case, The object collector 162 can receive the information that indicates the plurality of objects the user is interested in. The plurality of objects can be obtained from a source of objects 280 and visual representations of the plurality of objects can be displayed on the computer screen 240. The plurality of objects can be stored in temporary storage 172 that is associated with the collaborative clip board 230.

At step 310, a relationship between a group of the plurality of objects is established based on user specified information, according to another embodiment. For example, the user may want to coordinate a meeting to review a product analysis document to occur on date D1. To accomplish this, the user can cause the collaborative clip board 230 to establish a relationship between the document that needs to be reviewed (e.g., product analysis document), the people who are needed to review the document (Cheryl, Glen, and Mike), the date (D1) that the review should occur on, and a description desc1 (e.g., “scheduling meeting to review product analysis document”) of what is to occur. The relationship establisher 164 can receive the information (e.g., specifying Cheryl, Glen, Mike, date D1, the product analysis document, and the description desc1). The user can establish the relationship, for example, by dragging and dropping objects on top of each other, as already described herein

At step 315, a list of possible actions is provided for user selection, according to yet another embodiment. For example, one aspect of coordinating a review meeting involves sending an email to Cheryl, Glen, and Mike, attaching the product analysis document to the email, etc. In this case, the user cause the collaborative clip board 230 to provide a list of actions that can be performed on the specified group of objects. The collaborative clip board 230 can request and receive a list of potential actions from the tools for performing actions 290. The list of potential actions can include, among other things, messaging and calendaring.

The user can select the “messaging” action, for example, so that a message (e.g., email) is transmitted using the relationship and the group of objects. In this case, the collaborative clip board 230 can automatically cause the message to include a “cc:” to Cheryl, Glenn, and Mike, the product analysis document to be attached to the message, the description desc1, and the body of the message to include the date D1. The user can type in additional text for the message content.

At step 320, a user specified action, which is to be performed on the group of objects, is received, according to still another embodiment. For example, the user can click on the “send” button associated with the message system 292 to cause the message to be transmitted to the people designated on the “cc:”.

At step 325 of FIG. 3B, the plurality of objects and the relationship are stored in a database, according to one embodiment. For example, the people 252, documents 254, dates 256, and descriptions 258 can be stored in the database 274. Saving the plurality of objects and/or the relationship to permanent storage results in the creation of a workspace, according to one embodiment, that includes the plurality of objects and/or the relationship.

At step 330, the plurality of objects and the relationship are retrieved from the database, according to another embodiment. For example, at some later time, the user may want to perform another action on the plurality of objects and/or the relationship, such as coordinating a review of a design specification document. In this case, the user can cause the collaborative clip board 230 to retrieve information associated with a work space that includes the design specification document.

At step 335, a second relationship between a second group of objects is established based on user specified information, according to yet another embodiment. For example, Glen and Alok may be needed to review the design specification document on date D2. In this case, the text of description desc1 can read “scheduling meeting to review design specification document,” for example. The user can cause the relationship establisher 164 to establish a relationship between Glen, Alok, the design specification document, date D2, and the description desc2.

At step 340, a list of possible actions is provided for user selection, according to still another embodiment. For example, the tools for performing actions 290 can provide a list of potential actions to the collaborative clip board 230 that the collaborative clip board 230 can cause to be displayed on the computer screen 240.

At step 345 of FIG. 3C, a second user specified action is received, according to another embodiment. For example, the user can select the “messaging” action from the list. The resulting message can refer to the plurality of objects in a manner already described herein.

At step 350, the second user specified action is performed, according to still another embodiment. The message created in step 345 can be transmitted to Glen and Alok in a manner already described herein.

At step 355, objects associated with more than one workspace are searched based on user specified criteria, according to yet another embodiment. For example, assume that more than one workspace has been stored in permanent storage, such as database 274, as described in step 325. Also assume that certain workspaces have certain objects in common. For example, several workspaces may refer to the same document. A user that is interested in finding information associated with the same document may search for all of the workspaces that refer to that document, for example. Although this example was described in terms of performing a search based on a document, any object or any type of object can be used in a search.

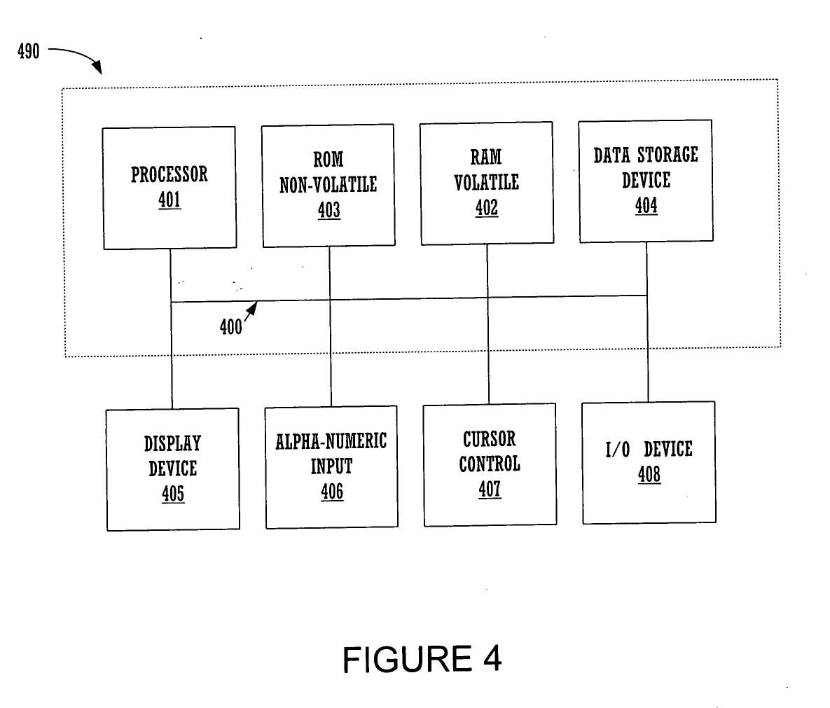

Now referring to FIG. 4, which illustrates an exemplary computer system 490 upon which embodiments of the present invention can be practiced. In general, computer system 490 comprises bus 400 for communicating information, processor 01 coupled with bus 400 for processing information and instructions, random access (volatile) memory (RAM) 402 coupled with bus 400 for storing information and instructions for processor 401, read-only (non-volatile) memory (ROM) 403 coupled with bus 400 for storing static information and instructions for processor 401, data storage device 404 such as a magnetic or optical disk and disk drive coupled with bus 400 for storing information and instructions, an optional user output device such as display device 405 coupled to bus 400 for displaying information to the computer user, an optional user input device such as alphanumeric input device 406 including alphanumeric and function keys coupled to bus 400 for communicating information and command selections to processor 401, and an optional user input device such as cursor control device 407 coupled to bus 400 for communicating user input information and command selections to processor 401. Furthermore, an optional input/output (I/O) device 408 is used to couple computer system 490 onto, for example, a network. According to one embodiment, a collaborative clipboard can be executed on the computer system 490.

The foregoing descriptions of specific embodiments of the present invention, a method and system for a collaborative clip board have been presented for purpose of illustration and description. The embodiments described herein allow people to collect objects, determine relationships between the objects, and perform actions on the objects in a natural way. They are not intended to be exhaustive or to limit the invention to the precise form disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of performing an action on related objects stored in a computer system, the method comprising:
collecting a plurality of objects into temporary storage associated with a collaborative clip board based on user specified first information;
establishing a relationship between a group of the plurality of objects based on user specified second information;
receiving a user specified action to be performed on the group of objects; and
performing the action based on the relationship between the group of objects.

2. A method as recited in claim 1, wherein the collecting the plurality of objects further comprises collecting a object from a group consisting of information about a person, a document, a message, a date, a description, and a place.

3. A method as recited in claim 1, wherein the receiving the user specified action further comprises receiving an action from a group consisting of messaging, inviting, scheduling, and calendaring.

4. A method as recited in claim 1 further comprising:
providing a list of potential actions for user selection; and
receiving information indicating which action a user selected from the list.

5. A method as recited in claim 1, wherein the performing the action is performed by a tool selected from a group consisting of a messaging tool, a calendaring tool, a scheduling tool, and an invite tool.

6. A method as recited in claim 1 further comprising:
storing one or more of the plurality of objects into permanent storage.

7. A method as recited in claim 6 further comprising:
storing one or more of the plurality of objects in a database.

8. A method as recited in claim 6 further comprising:
retrieving the plurality of objects from permanent storage;
establishing a second relationship between a second group of the plurality of objects based on user specified third information;
receiving a second user specified action to be performed on the second group of objects; and
performing the second action based on the second relationship between the second group of objects.

9. A method as recited in claim 6 wherein the plurality of objects stored in permanent storage form a workspace and wherein the method further comprises:
searching objects from more than one workspace based on user specified criteria.

10. A method as recited in claim 1 wherein the receiving the plurality of objects is performed by a generalized user interface (GUI).

11. A method as recited in claim 1, wherein the establishing the relationship between the group of objects further comprises receiving information indicating the relationship between the group of objects from a drag and drop operation.

12. A computer system comprising:
an object collector for collecting a plurality of objects into temporary storage associated with a collaborative clip board based on user specified first information;
a relationship establisher for establishing a relationship between a group of the plurality of objects based on user specified second information;
an action receiver for receiving a user specified action to be performed on the group of objects; and
an action performer that performs the action based on the relationship between the group of objects.

13. A computer system of claim 12, wherein the object collector collects a object from a group consisting of information about a person, a document, a message, a date, a description, and a place.

14. A computer system of claim 12, wherein the action receiver receives the action from a group consisting of messaging, inviting, scheduling, and calendaring.

15. A computer system of claim 12 further comprising:
a source of potential actions for providing a list of potential actions for user selection; and
an action receiver for receiving information indicating which action a user selected from the list.

16. A computer system of claim 12, wherein:
the action performer includes a tool for performing the action; and
the tool is selected from a group consisting of a messaging tool, a calendaring tool, a scheduling tool, and an invite tool.

17. A computer system of claim 12 further comprising:
permanent storage for storing one or more of the plurality of objects into permanent storage.

18. A computer system of claim 17, wherein the permanent storage is a database.

19. A computer system of claim 17 further comprising:
the relationship establisher establishes a second relationship between a second group of the plurality of objects based on user specified third information;
the action receiver receives a second user specified action to be performed on the second group of objects; and
the action performer performs the second action based on the second relationship between the second group of objects.

20. A computer-readable medium having computer-readable program code embodied therein for causing a computer system to perform a method of performing an action on related objects stored in a computer system, the method comprising:
collecting a plurality of objects into temporary storage associated with a collaborative clip board;
establishing a relationship between a group of the plurality of objects; and
performing an action based on the relationship between the group of objects.

21. A computer-readable medium as recited in claim 20, wherein the computer-readable program code embodied therein causes a computer system to perform the method, and wherein the collecting the plurality of objects further comprises collecting a object from a group consisting of information about a person, a document, a message, a date, a description, and a place.

22. A computer-readable medium as recited in claim 20, wherein the computer-readable program code embodied therein causes a computer system to perform the method, and wherein the method further comprises receiving an action from a group consisting of messaging, inviting, scheduling, and calendaring.

23. A computer-readable medium as recited in claim 20, wherein the computer-readable program code embodied therein causes a computer system to perform the method, wherein the method further comprises:
providing a list of potential actions for user selection; and
receiving information indicating which action a user selected from the list.

24. A computer-readable medium as recited in claim 20, wherein the computer-readable program code embodied therein causes a computer system to perform the method, and wherein the performing the action is performed by a tool selected from a group consisting of a messaging tool, a calendaring tool, a scheduling tool, and an invite tool.

25. A computer-readable medium as recited in claim 20, wherein the computer-readable program code embodied therein causes a computer system to perform the method, and wherein the method further comprises:
storing one or more of the plurality of objects into permanent storage.

26. A computer-readable medium as recited in claim 25, wherein the computer-readable program code embodied therein causes a computer system to perform the method, and wherein the method further comprises:
storing the one or more of the plurality of objects in a database.

27. A computer-readable medium as recited in claim 25, wherein the computer-readable program code embodied therein causes a computer system to perform the method, and wherein the method further comprises:
retrieving the plurality of objects from permanent storage;
establishing a second relationship between a second group of the plurality of objects; and
performing a second action based on the second relationship between the second group of objects.

28. A computer-readable medium as recited in claim 25 wherein the computer-readable program code embodied therein causes a computer system to perform the method, and wherein the plurality of objects stored in permanent storage form a workspace and wherein the method further comprises:
searching objects from more than one workspace based on user specified criteria.

30. A computer-readable medium as recited in claim 20 wherein the computer-readable program code embodied therein causes a computer system to perform the method, and wherein the receiving the plurality of objects is performed by a generalized user interface (GUI).

31. A computer-readable medium as recited in claim 20, wherein the computer-readable program code embodied therein causes a computer system to perform the method, and wherein the establishing the relationship between the group of objects further comprises receiving information indicating the relationship between the group of objects from a drag and drop operation.
